(19) United States
(12) Patent Application Publication
(10) Pub. No.: US 2023/0115235 A1
(43) Pub. Date: Apr. 13, 2023

(54) ENERGY MANAGEMENT SYSTEM, ENERGY MANAGEMENT METHOD, AND STORAGE MEDIUM

(71) Applicants: KABUSHIKI KAISHA TOSHIBA, Tokyo (JP); TOSHIBA ENERGY SYSTEMS & SOLUTIONS CORPORATION, Kawasaki-shi Kanagawa (JP)

(72) Inventor: Takaya SHONO, Fucho Tokyo (JP)

(73) Assignees: KABUSHIKI KAISHA TOSHIBA, Tokyo (JP); TOSHIBA ENERGY SYSTEMS & SOLUTIONS CORPORATION, Kawasaki-shi Kanagawa (JP)

(21) Appl. No.: 18/065,882

(22) Filed: Dec. 14, 2022

Related U.S. Application Data
(63) Continuation of application No. PCT/JP2020/023808, filed on Jun. 17, 2020.

(51) Int. Cl. H02J 3/00; G01W 1/10; G05B 13/04

(52) U.S. Cl. CPC H02J 3/003; G01W 1/10; H02J 3/004; G05B 13/048

(57) ABSTRACT

According to an embodiment, an energy management system includes an acquirer, a predictor, and a demand and supply controller. The acquirer acquires information provided by an unspecified user and including at least one of current meteorological situations and predicted future meteorological situations inside of a management area and outside of the management area and social environment situation patterns inside of the management area and outside of the management area acquired via a network. The predictor predicts one or both of an amount of demand for the energy and an amount of power generation in the future inside of the management area by analyzing or evaluating the demand and the supply of the energy on the basis of the information acquired by the acquirer. The demand and supply controller controls an energy demand and supply balance inside of the management area on the basis of prediction results of the predictor.

### CROSS-REFERENCE TO RELATED APPLICATIONS

This application is based upon and claims the benefit of priority from PCT/JP2020/023808, filed on Jun. 17, 2020; the entire contents of which are incorporated herein by reference.

### TECHNICAL FIELD

The present invention relates to an energy management system, an energy management method, and a storage medium.

### BACKGROUND ART

To perform a supply process in response to the demand for energy that fluctuates from moment to moment, energy management including predicting the demand and the occurrence thereof in various time slices, such as 10 minutes ahead, 1 hour ahead, 12 hours ahead, the next day, 1 week ahead, 1 month ahead, and 1 year ahead, and planning and controlling supply is performed. The demand for energy fluctuates probabilistically due to an influence of natural phenomena such as temperature and human social life patterns. Also, in power generation related to energy supply, an amount of power generation is also affected by the wind and sunlight for renewable energy power generation and a heat value of fuel in thermal power generation.

According to the invention described in Patent Document 1, the demand for electric power is predicted from data obtained by averaging meteorological prediction data associated with a region around a target point of a power demand prediction. Thereby, the average demand for electric power is predicted even if misalignment of the meteorological prediction occurs.

According to the invention of Patent Document 2, when a solution for an energy supply plan is obtained, a solution deviating from the exact solution is allowed and serves as a candidate for the final solution. Thereby, even if there are many constraints such as demand and the minimum operating time of a power generator, the start and stop of the power generator are planned close to the pattern of the start and stop of the power generator in an exact solution.

According to the invention of Patent Document 3, a prediction solution of a demand predictor and/or an error of an energy supply plan are controlled on the basis of the evaluation of the demand and supply condition from a future meteorological phenomenon and the demand for energy. Thereby, the quality (error) of the prediction solution and energy supply plan for an amount of demand for energy and/or an amount of power generation in the future is controlled on the basis of demand conditions.

### CITATION LIST

[Patent Document]
[Patent Document 1] Japanese Unexamined Patent Application, First Publication No. 2017-53804
[Patent Document 2] Japanese Unexamined Patent Application, First Publication No. 2015-99417
[Patent Document 3] Japanese Unexamined Patent Application, First Publication No. 2019-213299

### SUMMARY OF INVENTION

### Technical Problem

However, in the invention of Patent Document 1, a process of setting an appropriate prediction accuracy target suitable for the allowable accuracy of energy supply planning and control corresponding to a target range managed by the energy management device is not taken into account. It is difficult to plan and control energy supply under a meteorological condition deviating from a statistical average simply by assuming the average demand for energy.

Also, in the invention of Patent Document 2, a process of determining an amount of relaxation from an exact solution appropriate for the purpose of the energy management device is not taken into account. When the energy management device controls and plans energy supply in cooperation, there is a possibility that the relaxation of demand constraints and the relaxation of the exact solution of power generation plans based thereon will be overly implemented.

Furthermore, in the invention of Patent Document 3, the fluctuation of error and its responsiveness in a situation where demand and supply can change from moment to moment in real time more than ever before due to the large-scale introduction of renewable energy in the future and the full deregulation of the electricity retail market based on electricity deregulation are not taken into account sufficiently.

Therefore, according to the conventional technologies disclosed in the invention of Patent Document 1, the invention of Patent Document 2, and the invention of Patent Document 3, in a distributed system in which a plurality of energy management devices operate in cooperation, there is a problem that sufficient responsiveness and management are difficult with respect to a demand and supply balance on a power system and a social optimum value in a process of planning and control of energy supply that matches the demand for energy in the management area of the energy management device.

The present invention has been made in consideration of the above circumstances and provides an energy management system, an energy management method, and a storage medium (non-transitory computer storage medium) capable of predicting the supply or demand of energy more accurately and implementing the stable supply of energy with higher planning accuracy on the basis of a prediction result. For example, stable supply and adjustment control of energy can be performed with prediction accuracy and planning accuracy suitable for a situation in which demand and supply of energy change from moment to moment.

### Solution to Problem

According to an embodiment, an energy management system manages demand and supply of energy inside of a management area on the basis of results of predicting one or both of the demand and the supply of the energy inside of the management area. The energy management system includes an acquirer, a predictor, and a demand and supply controller. The acquirer acquires information provided by an unspecified user and including at least one of current meteorological situations and predicted future meteorological situations inside of the management area and outside of the management area and social environment situation patterns inside of the management area and outside of the management area acquired via a network. The predictor predicts one or both of an amount of demand for the energy and an amount of power generation in the future inside of the management area by analyzing or evaluating the demand and the supply of the energy on the basis of the information acquired by the acquirer. The demand and supply controller controls an energy demand and supply balance inside of the management area on the basis of prediction results of the predictor.

### BRIEF DESCRIPTION OF DRAWINGS

FIG. 1 is a diagram showing an example of a functional configuration of an information processing system 1.

FIG. 2 is a flowchart showing an example of a flow of a process executed by an energy management system 10.

FIG. 3 is a diagram for describing an example of information used to predict an amount of demand or an amount of power generation.

FIG. 4 is a conceptual diagram of a trained model 34 for outputting an amount of demand or an amount of power generation.

FIG. 5 is a diagram showing an example of a functional configuration of an information processing system 1A according to a third embodiment.

FIG. 6 is a conceptual diagram of a simulation model for outputting an amount of demand or an amount of power generation in the future.

FIG. 7 is a diagram showing an example of a functional configuration of an information processing system 1B according to a fourth embodiment.

FIG. 8 is a diagram showing an example of a functional configuration of an information processing system 1C according to a fifth embodiment.

FIG. 9 is a diagram showing an example of a functional configuration of an information processing system 1D according to a sixth embodiment.

FIG. 10 is a diagram showing an example of a functional configuration of an information processing system 1E according to a seventh embodiment.

### DESCRIPTION OF EMBODIMENTS

Hereinafter, an energy management system, an energy management method, and a storage medium of embodiments will be described with reference to the drawings.

### <Overview>

The energy management system, the energy management method, and the storage medium of the embodiments can be applied to, for example, a distributed energy management system including a plurality of energy management devices that predict the demand and/or supply of energy inside of a management area and manage energy inside of the management area on the basis of prediction results, a measurement and control terminal, and the like.

In the energy management system, the energy management method, and the storage medium of the embodiments, peripheral information about power demand and generation such as current and future meteorological information is acquired and the energy demand and supply balance inside of the management area is controlled on the basis of the acquired information. For example, information such as a social networking service (SNS) on the Internet is picked up and analyzed to contribute to improving the accuracy of predicting supply or demand of energy. The energy management system, the energy management method, and the storage medium are configured to provide a predictor configured to predict an amount of energy demand and/or an amount of power generation in the future inside of a management area, and a function in which control of power demand and supply inside of the management area, a protection and control function of system equipment, and a substation equipment monitoring function are linked on the basis of real-time prediction results of the predictor.

Thereby, a process of increasing an amount of information and improving the accuracy for modeling the power system in the energy management system, the energy management method, and the storage medium contributes to improving the accuracy of predictions by simulating the behavior of the power system such as future electrical phenomena and to suppressing errors between future simulation predictions and actual phenomena by reflecting the influence of the surrounding environment that changes from moment to moment. For example, using the above-described SNS information for use in a simulation process, the accuracy related to the demand for energy or the prediction in the simulation process is further improved. In order to achieve the above objective, the energy management system, the energy management method, and the storage medium of the embodiments have the following functional configurations.

### First Embodiment

The energy management system manages the demand and supply of energy inside of the management area on the basis of prediction results of one or both of the demand and supply of energy inside of the management area. The energy management system acquires information including at least one of current meteorological situations and predicted future meteorological situations inside of the management area and outside of the management area and social environment situation patterns inside of the management area and outside of the management area, analyzes or evaluates the demand and supply of energy on the basis of the acquired information, and predicts one or both of an amount of demand for the energy and an amount of power generation in the future inside of the management area. The energy management system controls a demand and supply balance of energy inside of the management area on the basis of prediction results.

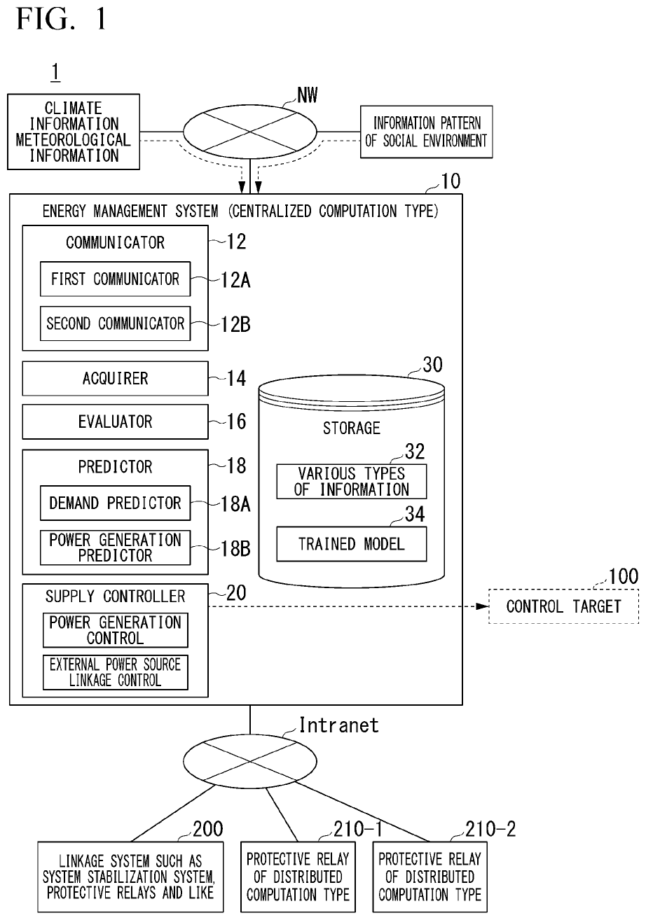

FIG. 1 is a diagram showing an example of a functional configuration of an information processing system 1. The information processing system 1 includes, for example, an energy management system 10, a control target 100, a linkage system 200, a protective relay 210-1, and a protective relay 210-2. Hereinafter, when the protective relay 210-1 and the protective relay 210-2 are not distinguished, they may be referred to as a “protective relay 210.” The information processing system 1 or the energy management system 10 is an example of an “energy management system.”

The energy management system 10 is connected, for example, to a network NW. The network NW includes, for example, the Internet, a wide area network (WAN), a provider device, a radio base station, or the like. The energy management system 10 acquires various types of information via the network NW. The various types of information include, for example, weather information about weather (short-term meteorological changes) or climate information about a climate (relatively long-term meteorological changes), meteorological information about a meteorological phenomenon, social environment information, and the like.

The energy management system 10 is also connected to, for example, an intranet. The intranet is a network for communicating with devices to be linked by the energy management system 10. The linkage system 200, the protective relay 210, and the like are connected to the intranet. The energy management system 10 communicates with the linkage system 200 or the protective relay 210 via the intranet. The control target 100 is a device controlled by the energy management system 10 such as a power generator. Also, the control target 100 is a device that affects power demand and includes all electrical loads for use in social activities, economic activities, or the like. The control target 100 includes, for example, equipment that consumes electric power in a factory, a commercial facility, a general household, or the like. Also, the control target 100 includes circuit breakers, disconnectors, transmission line jumpers, and phase modifying equipment for controlling power generators owned by existing electric power companies, various types of power sources owned by new electric power companies, which are also called a specific-scale electricity provider, a power producer and supplier (PPS), and the like, power transmission and distribution routes, and the like.

The linkage system 200 includes a system stabilization system and the like. For example, the system stabilization system forcibly disconnects a part of the power generator from the power system in accordance with abnormal phenomena that may occur in the target power system (for example, a discoordination phenomenon, a frequency abnormality, a voltage abnormality, and an overload) and the like and performs power restriction, load shutdown, and the like. Thereby, the influence of the system failure is prevented from spreading throughout the system. Also, the linkage system 200 may include a protective relay, a monitoring control system, a substation equipment monitoring system, and the like in addition to the system stabilization system.

Computation to which main functions of a system stabilization system, a system linked to protective relays and the like, and a device and information (for example, an SNS) obtained from a network NW (the Internet) associated therewith have been applied may be of a centralized computation type in a server including the energy management system 10 and the like or a distributed computation type for performing computations individually distributed in systems and devices such as terminals in a system stabilization system, a protective relay device, and the like mutually linked via the network (for example, the intranet) (for example, a distributed computation type in a closed network within an electricity company). Also, computation to which main functions of a system stabilization system, a system linked to protective relays and the like, and a device and information (for example, an SNS) obtained from a network NW (the Internet) associated therewith have been applied may be distributed computation in a cloud environment without depending on a physical location.

A general management target of the energy management system 10 is the following functional requirements. Also, the energy management system 10 does not depend on a size of a management area, a level of the voltage class, a business area, or a business operator and includes the following EMSs. Only these EMSs all have different scopes for managing energy. Specifically, at least the following EMSs are targeted.
HEMS=Home EMS: EMS for home use
MEMS=Mansion EMS: EMS for apartment buildings (mansions)
BEMS=Building EMS: EMS for commercial buildings
FEMS=Factory EMS: EMS for factories
CEMS=Cluster/Community EMS: EMS for regions

Also, a specific management target of the energy management system 10 is the following functional requirements. The energy management system 10 performs a process of visualizing an amount of power used in an energy supervision area, system and equipment control processes for saving electricity (the reduction of CO₂), a process of controlling renewable energy devices such as solar power generators and power storage devices, and the like. Although management targets of energy management systems 10 are different, the basic functional requirements of the system of controlling the monitoring of power demand and power supply are common and are associated with at least the “visualization” of a usage situation of energy such as electricity or electric power, the analysis of the “visualized” usage situation of energy, the finding of places where the reduction of fuel consumption, equipment operation, and the like is possible, and the reduction of the fuel and management cost.

The energy management system 10 includes, for example, a communicator 12, an acquirer 14, an evaluator 16, a predictor 18, a supply controller 20, and a storage 30. The communicator 12 is a communication interface including a first communicator 12A and a second communicator 12B. The first communicator 12A is a communication interface that communicates with other devices via the network NW. The second communicator 12B is a communication interface that communicates with other devices via the intranet.

Some or all of the acquirer 14, the evaluator 16, the predictor 18, and the supply controller 20 are implemented by, for example, a processor such as a central processing unit (CPU) executing a program (software) stored in the storage 30. Also, some or all of the functions of these components may be implemented by hardware (including a circuit unit: circuitry) such as a large-scale integration (LSI) circuit, an application specific integrated circuit (ASIC), a field-programmable gate array (FPGA), and a graphics processing unit (GPU) or may be implemented by software and hardware in cooperation. The program may be stored in a storage 30 such as a hard disk drive (HDD) or a flash memory in advance or may be stored in a removable storage medium such as a DVD, a CD-ROM, or a USB memory and installed when the storage medium is mounted in a drive device. Also, the program may also be provided via communication such as a network NW by an external device and installed to enhance or improve functions. In the storage 30, various types of information 32 and a trained model 34 (details will be described below) obtained via the above-described network NW are stored.

The acquirer 14 acquires information provided by an unspecified user and including at least one of current meteorological situations and predicted future meteorological situations inside of the management area and outside of the management area and social environment situation patterns inside of the management area and outside of the management area acquired via the network NW. The user is, for example, a user who uses an SNS. This user is a user who is not involved in the energy business, but may be a user involved in the energy business such as energy management (a power generation and transmission business operator or a social infrastructure operator related to the energy business). The information provided by the unspecified user is, for example, information included in a list of search results provided by a search service when a prescribed word (or sentence) is used as a search word in the search service or information included in a link destination of the list. The prescribed word is, for example, a preset word. For example, this prescribed word may be stored in the storage 30 or may be a word provided from an external device. For example, words/clauses related to weather or meteorological phenomena such as “sunny,” “it's about to start raining,” “it's about to stop raining,” “lightning flashes were seen in the distance,” “thunder was heard,” “muggy,” and “the sun is about to be hidden by clouds,” words/clauses similar to these words/clauses, or words/clauses including these words/clauses may be used for the prescribed word. If a word is preset, information can be easily obtained from the SNS using this set word. Also, the information provided by the search service may include information provided by public institutions, or this information may be excluded and only information provided by general users may be included.

The evaluator 16 analyzes or evaluates energy demand and supply on the basis of the information acquired by the acquirer 14.

The analysis includes, for example, demand-side analysis and supply-side analysis. The supply-side analysis is, for example, the prediction of an increase in the demand for electric power because the temperature rises and air conditioning is required if it is about to be sunny or the analysis for the demand and supply balance or the like because the demand for the electric power increases due to the need for heating if it is about to snow, whereas people's outings and activities are restricted and the demand for the electric power decreases due to the restriction. Also, these analysis processes can reflect learning results of past data trends in the analysis. Demand is also affected by social conditions (for example, a request to refrain from going out due to the corona shock in 2020). The analysis for the demand and supply balance is performed because, if the risk of a pandemic or medical collapse increases, socio-economic activities will be restricted and the demand for the electric power will tend to decrease, but the number of people staying at home will increase.

The supply-side analysis is, for example, a process of analyzing that solar radiation can be expected to increase and an amount of solar power generation can be expected to increase if it is about to be sunny and an amount of wind power generation can be expected to increase if the wind is likely to be strong or the like. Also, if the wind is strong around the power transmission line, a cooling effect can be expected and the power transmission efficiency tends to increase. Also, the analysis shows that a bidding situation of new electric power companies such as a specific-scale electricity provider and a power producer and supplier (PPS) and electricity retailers in the electricity market is affected by fuel unit prices and a business situation of related stakeholders and the electrical tolerance of energy supply is affected thereby.

An evaluation process is a process of evaluating how accurate and credible the analysis results are in comparison with past accumulated information. If the planned control logic does not include a degree of electrical tolerance (allowance) in consideration of a certain amount of risk, there is a possibility that it becomes uncontrollable when there is a discrepancy between the analysis result (prediction) and the actual situation.

The predictor 18 predicts one or both of an amount of energy demand and an amount of power generation in the future inside of the management area. The predictor 18 includes a demand predictor 18A and a power generation predictor 18B. The demand predictor 18A predicts the demand for energy generated by social activities inside of the management area. The power generation predictor 18B predicts an amount of power generated by natural energy that is beyond the reach of artificial control, such as wind power and solar power. The supply controller 20 controls a demand and supply balance of energy inside of the management area on the basis of prediction results of the predictor 18.

For example, when the supply controller 20 predicts that the demand of a certain system will increase to a prescribed degree, the supply controller 20 controls the target 100, the linkage system 200, the protective relay 210, and the like on the basis of a prediction result so that the demand and supply balance of the system is balanced in real time. The supply controller 20 executes power generation control and external power source interlinkage control. Power generation control is a control process of controlling the power generator itself and achieving the above-described balance. External power source interlinkage control is a process of controlling the amount of power generated by interlinkage/disconnection with the above-described new electricity of the specific scale electricity business operator, the PPS, or the like and the electricity retailer. The supply controller 20 appropriately combines the above-described control processes and performs a control process so that the demand and supply balance of the system is achieved in real time.

For example, even if it is difficult to make exact predictions of sunshine, wind conditions, thunderstorms, and the like in the change of seasons and the like, it is possible to predict the movement of clouds and the amount of sunlight 10 minutes ahead more accurately by taking into account real-time information of an SNS and the like. For example, it is possible to predict a sudden increase in the amount of sunlight after the thunderclouds pass. Although the amount of solar power generation suddenly increases, the temperature rise due to the increase in sunlight and the muggy heat after rain overlap and the amount of operation of the air conditioner increases. Thus, it is possible to predict the demand and supply balance in the collation with past trends and to bring the demand and supply balance and their costs closer to the optimal value while taking into account the efficiency of power generation and interlinkage with electricity retailers.

### [Flowchart]

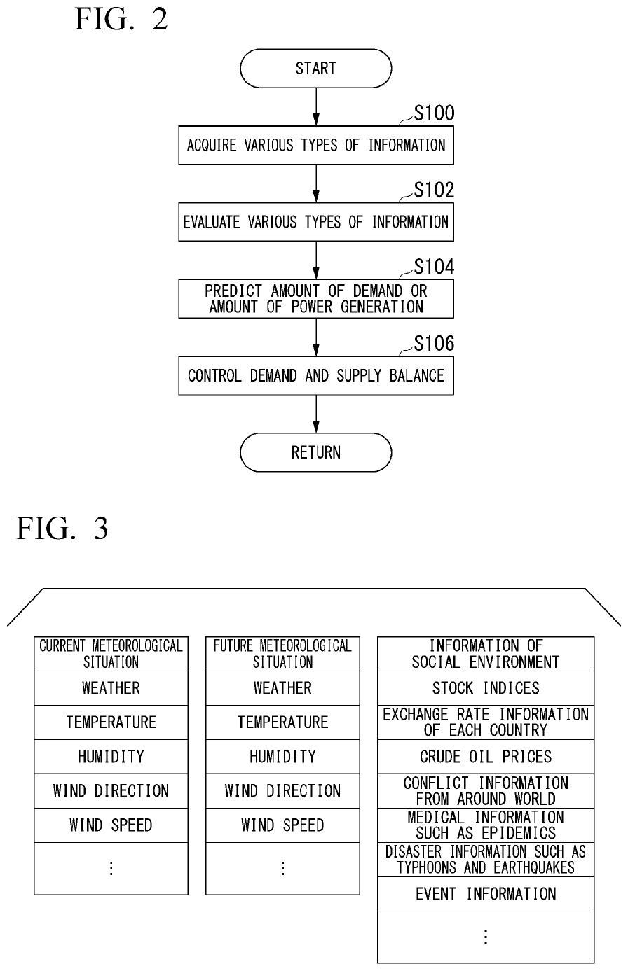

FIG. 2 is a flowchart showing an example of a process flow executed by the energy management system 10. First, the acquirer 14 acquires various types of information 32 stored in the storage 30 (step S100). Subsequently, the evaluator 16 evaluates the various types of information 32 acquired in step S100 (step S102). Subsequently, the predictor 18 predicts an amount of demand or an amount of power generation on the basis of evaluation results of step S102 (step S104). Subsequently, the supply controller 20 controls a demand and supply balance on the basis of a prediction result in step S104 (step S106).

Here, an example of a method in which the predictor 18 predicts tan amount of demand or an amount of power generation will be described. The predictor 18 predicts the amount of demand or the amount of power generation generated using, for example, a part or all of the information included in the following information (1) to (3). FIG. 3 is a diagram for describing an example of information for use in predicting an amount of demand or an amount of power generation.

(1) Current meteorological situation in target region

The current meteorological situation in the target region includes, for example, a part or all of the following information:
Weather (sunny, cloudy, rainy, cloudiness, and the like)
Temperature
Humidity
Wind direction
Wind speed

(2) Future meteorological situation in target region

The future meteorological situation in the target region includes, for example, or all of the following information:
Weather (sunny, cloudy, rainy, cloudiness, and the like)
Temperature
Humidity
Wind direction
Wind speed

(3) Information about social environment (situation patterns of social environment)

The information of the social environment includes, for example, a part or all of the following information. The following information is considered to be correlated with energy demand and supply. If this information is collated with data accumulated in the past, the correlation can be understood, and the learning effect of a knowledge database (a learning model) will increase as the accumulation of data increases. Information about the social environment is not limited to the SNS, but includes information obtained via the network NW or intranet.
Stock indices: NY Dow, Nasdaq, Nikkei Average, Nikkei 225, etc.
Exchange rate information of each country
Crude oil prices
Conflict information from around world
Medical information such as epidemics
Disaster information such as typhoons and earthquakes
Events: Events include large-scale events such as the Olympics and the World Cup, as well as New Year's first visits, homecoming/vacations during long holidays, concerts, and sporting events such as professional baseball and soccer.

The predictor 18 predicts an amount of demand or an amount of power generation using, for example, a first method or a second method. The first method is a method of indexing each of the above-described information and predicting the amount of demand or the amount of power generation on the basis of an index. For example, an amount of demand or an amount of power generation tends to increase (a required amount of power generation or an amount of power expected to be generated by a given system) as the index obtained from certain information increases and an amount of demand or an amount of power generation tends to decrease as an index obtained from other information increases. For example, information indicating these correlations is stored in the storage 30 in advance.

For example, the index is set to increase as a difference of the current temperature in a certain specific region from the reference value increases (as the temperature increases or decreases). In this case, it is assumed that both an amount of demand and an amount of power generation will increase due to the use of equipment such as air conditioning devices. For example, the index is set to increase as the stock index of each country increases with respect to the reference value. In the case of stock indices, it is generally assumed that economic activity will become active and both an amount of demand and an amount of power generation will increase when the stock price is greater than the reference value, whereas it is assumed that both an amount of demand and an amount of power generation will decrease when the stock price is less than the reference value. The reference value is, for example, a moving average for a prescribed period, the stock price of the previous day, or the like.

Also, indices are similarly derived on the basis of deviations from reference values with respect to currency exchange rate information of each country, crude oil prices, information of conflicts around the world, medical information such as epidemics, disaster information such as typhoons and earthquakes, and information of large-scale events. Likewise, in this case, the index corresponding to the state in a past prescribed period or a prescribed period is the reference value. When each of the indices corresponding to crude oil prices, information of conflicts around the world, medical information such as epidemics, and disaster information such as typhoons and earthquakes tends to be larger than the reference value (when crude oil prices increase and a degree of occurrence of conflicts, epidemics, typhoons, earthquakes, or the like increases), economic activity is expected to be suppressed and demand and an amount of power generation is expected to decrease. As described above, the amount of demand or the amount of power generation may tend to increase when the index obtained from a certain information is greater than the reference value and the amount of demand or the amount of power generation may tend to decrease when the index obtained from information different from the above is greater than the reference value.

The second method is a method using the trained model 34. The trained model 34 is, for example, a learning model such as deep learning or a neural network. The trained model 34 is a trained learning model using information including a part or all of information of the past meteorological phenomenon or social environment and the information of an amount of demand or an amount of power generation associated with the above-described information as learning data. The trained model 34 is a model trained to output the amount of demand or the amount of power generation associated with the above-described information when a part or all of the information of the past meteorological situation or social environment is input. Also, the trained model 34 described above may be a model for outputting an estimated value of a current state or a difference value from a value actually measured in real time as well as an absolute value of the amount of demand or the amount of power generation. In this case, the trained model 34 is generated by learning the learning data in which an estimated value or a difference value is associated with a part or all of information of the past meteorological phenomenon or social environment.

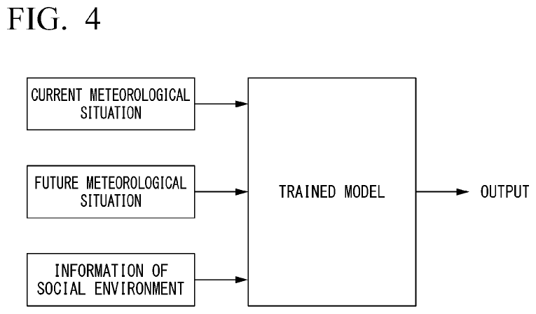

For example, the predictor 18 vectorizes information of a part or all of the information on the current meteorological situation, the past meteorological situation, or the social environment, or information of a set of a part or all thereof, inputs the vectorized information to the trained model 34, and predicts the amount of demand or the amount of power generation on the basis of information output from the trained model 34. FIG. 4 is a conceptual diagram of the trained model 34 for outputting an amount of demand or an amount of power generation.

As described above, the energy management system 10 can predict the amount of demand or the amount of power generation with higher accuracy using a part or all of the past meteorological phenomenon or social environment information (for example, social environment information).

According to the first embodiment described above, it is possible to predict the demand or supply of energy more accurately and stably supply energy with higher planning accuracy on the basis of a prediction result by one or both of the amount of demand for the energy and the amount of power generation in the future inside of the management area by predicting the demand and the supply of the energy using information including at least one of current meteorological situations and predicted future meteorological situations inside of the management area and outside of the management area and social environment situation patterns inside of the management area and outside of the management area and controlling an energy demand and supply balance inside of the management area on the basis of the prediction result.

### Second Embodiment

Hereinafter, a second embodiment will be described. In the first embodiment, the amount of demand or the amount of power generation is predicted on the basis of the information of the meteorological phenomenon and the social environment obtained by an energy management system 10. On the other hand, an energy management system 10 of the second embodiment acquires SNS information provided via a network NW and predicts an amount of demand or an amount of power generation using the acquired information. Hereinafter, differences from the first embodiment will be mainly described.

The SNS information is so-called muttering information, tweeting information, following information, and the like related to a weather/meteorological phenomenon or people's consciousness in a certain specific area on the SNS. For example, this information is posted to a server for receiving posts of information such as text and providing a service that makes the received posts viewable by a target user and is information capable of being viewed by an unspecified number of users. Also, this information can be a significant parameter for predicting the weather/meteorological phenomenon in the time slice or people's behavior patterns in the near future from their correlation according to past performance.

The energy management system 10 can extract keywords related to temperature, humidity, and solar radiation such as “hot/cold,” “muggy/cool,” “sunny/cloudy” from the SNS in a certain specific area and uses the extracted keywords as an alternative to actual measurement data of temperature and humidity more precise than those at mesh-like observation points when the number of extracted keywords exceeds a prescribed threshold value. Also, these will lead to predictions of energy demand such as the operation of air conditioning and heating in the near future.

Also, if keywords related to earthquakes such as “shook,” “shook strongly,” and “cupboards collapsed” are extracted in a specific area, they can be used to predict system failures in other regions and to quickly identify the extent of power outages based on the principle of seismic wave propagation.

Also, if keywords related to wind power and wind direction, such as “windy,” “northerly/southerly wind,” “gust,” and “tornado,” are extracted in a specific area, they can be used for more detailed evaluation of power transmission and distribution efficiency due to the contact short circuit of power transmission and distribution lines by wind or the cooling of power transmission and distribution lines by wind.

Also, if keywords related to lightning strikes such as “rain/thunderstorm,” “lightning,” “thunder,” and “flash” are extracted in a specific area, they can be used for system failure detection such as power transmission and distribution line ground faults caused by lightning strikes and for early prediction.

For example, the energy management system 10 inputs the above-described information obtained from the SNS to the trained model 34 and predicts the amount of demand or the amount of power generation on the basis of a result output by the trained model 34. The trained model 34 is a model in which learning data has been learned. The learning data is information in which the above-described “word” or “number of words” and the current or future meteorological phenomenon, the current or future social environment, the amount of future demand for energy inside of the management area, or the amount of future power generation of energy inside of the management area when “word” or “number of words” appears are associated. The trained model 34 is a model trained to output information indicating the meteorological phenomenon and the social environment, the amount of future demand for energy inside of the management area, or the amount of future power generation of energy inside of the management area when “word” or “number of words” appears if “word” or “number of words” is input. Also, the first method may be used instead of the second method as described above. In this case, for example, when the number of times a prescribed word appears is greater than or equal to a threshold value, a region where the word appears is estimated to be under an environment corresponding to a prescribed word.

According to the second embodiment described above, the energy management system 10 can predict energy demand or supply more accurately on the basis of information obtained from the SNS on the Internet and implement the stabilized supply of energy with higher planning accuracy on the basis of a prediction result.

### Third Embodiment

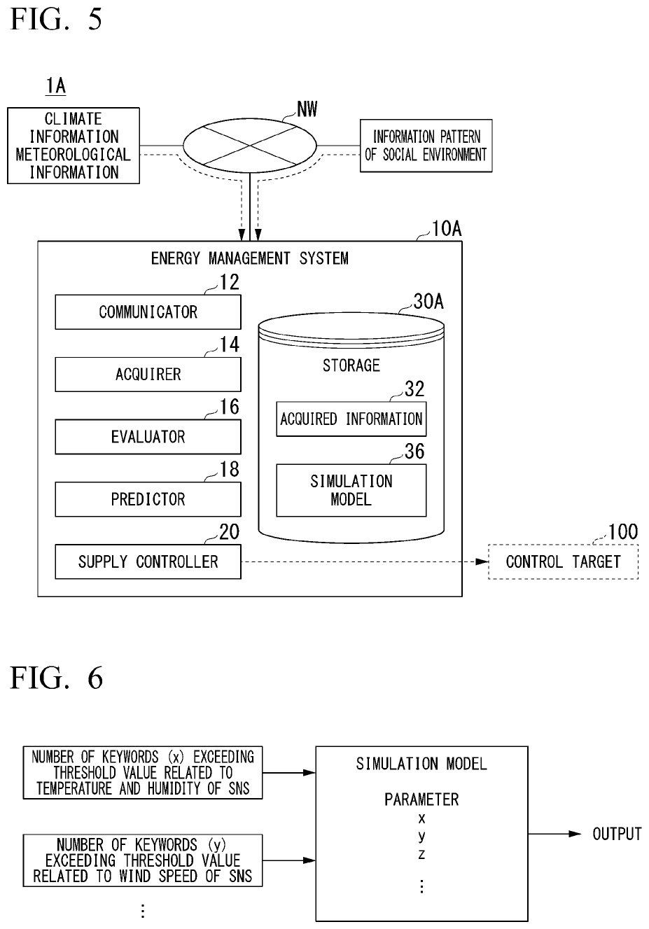

Hereinafter, a third embodiment will be described. In the third embodiment, an energy management system 10A (see FIG. 5) predicts an amount of demand or an amount of power generation using a simulation model (a system model). The energy management system 10A applies SNS information to parameters of the simulation model for simulations of various electrical phenomena of the system using the parameters of a preset power system voltage and a preset power system current and a system model of system equipment. For example, the energy management system 10A acquires SNS information for simulations of various electrical phenomena of the system using a normal power system voltage and current and system equipment parameters and uses the acquired SNS information as new additional parameters in current and future simulation models and state simulations thereof. Hereinafter, differences from the first embodiment or the second embodiment will be mainly described.

For example, an air temperature, humidity, solar radiation, and wind speed around the power transmission line are useful parameters for actual line constant identification in terms of making the simulation model more rigorous and accurate. A local air temperature, humidity, solar radiation, wind speed, and the like require the installation of sensors and the development of a communication network to collect sensor information. A major challenge in installing sensors and developing a communication network is the balance between their density and equipment cost. However, by collecting various written and scattered information on the SNS and analyzing the collected information as so-called big data, it is possible to achieve the amount and accuracy of information greater than or equal to those of meteorological information or weather forecasts published by public institutions using conventional methods.

FIG. 5 is a diagram showing an example of a functional configuration of an information processing system 1A of the third embodiment. The information processing system 1A includes an energy management system 10A instead of the energy management system 10. The energy management system 10A includes a storage 30A instead of the storage 30. In the storage 30A, various types of information 32 and a simulation model 36 are stored. The simulation model 36 is, for example, a function having various parameters. Hereinafter, an example of the parameters will be described.

In so-called muttering, tweeting, following, and the like related to the weather, the meteorological phenomenon, or people's consciousness in a certain specific area on the SNS, the weather/meteorological phenomenon in the time slice can be an electrical characteristic parameter (a line constant or the like) of the power system or a significant parameter for predicting the energy consumption (load) caused by people's behavior patterns in the near future from their correlation based on past performance

Specifically, the energy management system 10A can extract keywords related to a temperature and humidity such as “hot/cold” and “muggy/cool” from the SNS in a certain specific area and use the extracted keywords as an alternative to actual measurement data of temperature and humidity more precise than those at rough mesh-like observation points when the number of extracted keywords exceeds a prescribed threshold value. Thus, it is possible to calculate an influence of temperature and humidity on the electrical characteristic parameters of the power system. By giving the parameters as described above, it contributes to the suppression of errors between electrical characteristic parameters and actual electrical parameters in equipment design, and these lead to the prediction of energy demand (load) such as operating air conditioning and heating in the near future. For example, if predictions are made by applying a simulation model to each more subdivided region, it is possible to predict energy demand (load) for each more subdivided region. These contribute to the construction of more rigorous simulation models and higher definition state simulations of power systems thereby.

Also, if keywords related to wind power, a wind direction, and solar radiation are extracted in a specific area, they can alternatively be used for more precise evaluation (dynamic rating) of power transmission and distribution efficiency by heating and cooling of power equipment such as power transmission and distribution lines and transformers by wind.

FIG. 6 is a conceptual diagram of a simulation model for outputting an amount of demand or an amount of power generation in the future. The simulation model 36 is, for example, a function that includes one or more parameters. For example, an index in which information obtained from the SNS is normalized becomes an argument applied to the parameter. For example, the number of keywords related to the temperature and humidity of the SNS and the number of keywords related to the wind strength of the SNS are arguments applied to parameters. Each of the arguments applied to the parameters is limited to, for example, those that exceed a threshold value.

Even in the dynamic rating, an allowable current of the power transmission line is determined using a simulation model applied to the dynamic rating according to a concept similar to that described above.

Also, information obtained from the SNS may be added to the index output by the simulation model. In this case, the above-described SNS information may or may not be taken into account in the parameters of the simulation model.

According to the third embodiment described above, the energy management system 10A can perform a simulation process for various electrical phenomena of a system using a simulation model for predicting one or both of an amount of energy demand and an amount of power generation in the future inside of the management area and parameters of the simulation model for a preset power system voltage and current and system equipment and can predict one or both of an amount of energy demand and an amount of power generation in the future inside of the management area more accurately by applying the SNS Information to the parameters of the simulation model in the simulation process. For example, if a simulation model is applied for each more detailed region, it is possible to predict one or both of an amount of demand and an amount of power generation in the region more accurately.

### Fourth Embodiment

Hereinafter, a fourth embodiment will be described. An energy management system 10A of the fourth embodiment acquires SNS information and performs an information sharing and interlinkage process for a system model and its state simulation result with a system stabilization system (a cascading failure prevention relay system). Interlinkage indicates, for example, that the system stabilization system performs a control response process on the basis of information obtained from the energy management system 10A. Hereinafter, differences from the first to third embodiments will be mainly described.

Conventional system stabilization systems calculate the static stability of the system, the transient stability, and the like using various methods. If a deviation between the set value of the system parameter and the actual value is large, a simulation result after the system failure will deviate from the actual phenomenon as a result. If the system stabilization system (the cascading failure prevention relay system) causes a control response error, it will lead to a large-scale power outage or the like and therefore the number of blocked loads and the limited number of power sources are often determined in advance with a certain margin in principle. As described above, if the system parameters and the meteorological information or weather forecast have the amount of information and the accuracy at least equivalent to those of the conventional system parameters and the conventional meteorological information or weather forecast by performing big data analysis on the SNS, a discrepancy between the simulation result after the system failure and the actual phenomenon can be minimized and the number of blocked loads and the limited number of power sources can be minimized as a result. Thereby, it is possible to minimize the range of power outages and to consult on early recovery after system stoppage.

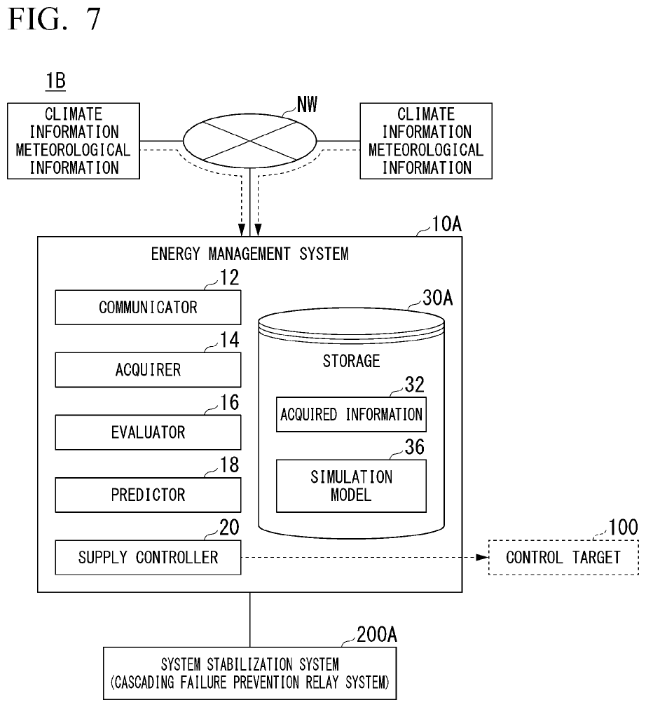

FIG. 7 is a diagram showing an example of a functional configuration of an information processing system 1B of the fourth embodiment. For example, the information processing system 1B includes a system stabilization system (a cascading failure prevention relay system) 200A in addition to the energy management system 10A.

As in the third embodiment described above, because the weather/meteorological phenomenon in the time slice can be an electrical characteristic parameter (line constants such as power transmission line resistance, inductance, capacitance, and leakage conductance, and other characteristic parameters) of the power system or a significant parameter for predicting energy consumption (load) caused by people's behavior patterns in the near future from their correlation based on past performance, the contribution to improving the accuracy and performance of the system stabilization system 200A increases.

According to the fourth embodiment described above, the energy management system 10A can contribute to consulting on minimizing the power failure range and early recovery after system stoppage.

### Fifth Embodiment

Hereinafter, a fifth embodiment will be described. The energy management system 10A of the fifth embodiment acquires SNS information and performs an information sharing and interlinkage process for a system model and its state simulation result with protective relay devices or a protective relay system linked thereto. Interlinkage indicates, for example, that protective relay devices or a protective relay system linked thereto performs a control response process on the basis of information obtained from the energy management system 10A. Hereinafter, differences from the first to fourth embodiments will be mainly described.

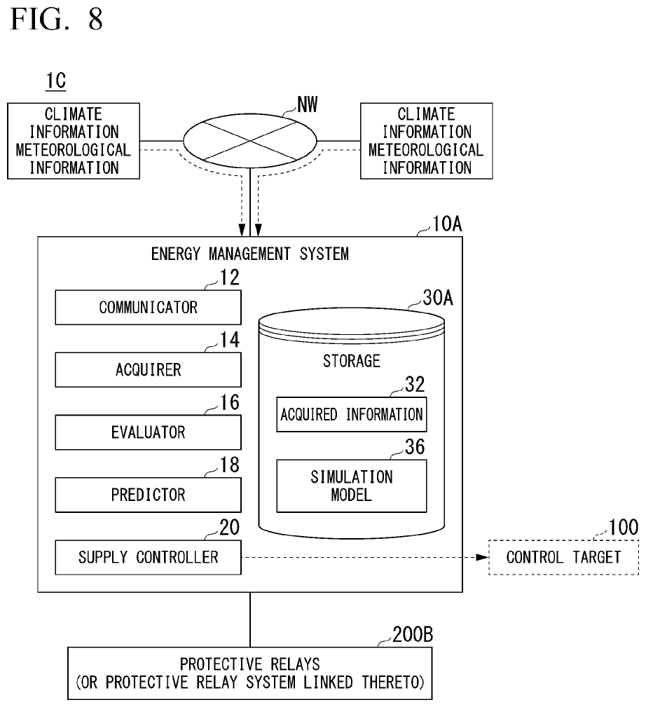

FIG. 8 is a diagram showing an example of a functional configuration of an information processing system 1C of the fifth embodiment. For example, the information processing system 1C includes protective relays 200B (or a protective relay system linked thereto) in addition to the energy management system 10A.

Conventional protective relay devices or a protective relay system linked thereto use various methods to play a role of detecting abnormal phenomena (system equipment failures) that occur in the power transmission lines and substations of the system in a very short time (about 10 to 30 ms), outputting a pullout instruction to a circuit breaker, and temporarily separating an abnormality location of the system equipment from the main system.

The factors and causes of these failures on the power system include short circuits and ground faults between power transmission lines due to lightning strikes caused by thunderclouds due to bad weather in the case of power transmission lines, abnormalities due to overload caused by an operation that exceeds the design performance or the like in the case of other equipment, and the like. In order to detect abnormal phenomena that occur in the power transmission line and substation equipment of the system, the current/voltage value of the system or equipment is generally measured, for example, various parameters such as line constants if the power transmission line is a protection target, or the heat generation of the power transmission line cable in the case of overload detection are taken into account. Thus, a surrounding temperature, seasonal information such as summer and winter, and the like are also important parameters of an algorithm applied to abnormality detection. If there is an actual abnormality in the system equipment, it is desirable to detect the abnormality as early as possible and take appropriate action such as a pullout process of the circuit breaker. This indicates the shutdown of power supply equipment, i.e., it leads to a power outage in the target area. Therefore, if there is a minor abnormal event such as an intermittent ground fault or overload of a significantly short time, it is desirable to continue the operation of the system equipment without detecting any abnormality from the viewpoint of stable supply of electric power.

Also, because the detection of presence or absence of abnormalities on the system equipment bears an extremely important responsibility, for example, if the power transmission line is a protection target, the accuracy and credibility of various parameters such as the line constants and the setting of a determination threshold value of a calculation result of an algorithm to which these parameters are applied (regulation in the field of protective relay) are significantly important.

As the SNS information mentioned herein, in protective relay devices or a system linked thereto, meteorological and weather information or information having a higher real-time property for each regional area associated with a meteorological phenomenon or weather becomes significantly useful information for increasing an information density of a parameter of an abnormality detection algorithm, improving the credibility of the parameter, and automatically setting its threshold value.

The purposes of applications of various parameters are as follows.
A temperature and humidity around the power transmission line affect, for example, the impedance of the power transmission line. Therefore, a meteorological/weather forecast, i.e., temperature, humidity, or real-time information thereof, is significantly useful for improving the accuracy of failure selectivity (whether or not it should be detected as a failure) of a so-called distance relay method (distance measurement impedance method) in which impedance information of the power transmission line is applied to the abnormality detection algorithm. Also, because this distance measurement impedance method is a common principle for failure point identification devices of the power transmission line or a system linked thereto, it is also effective for improving the accuracy of the failure identification process.
In frequency relay devices or a system linked thereto, a frequency calculation algorithm and a calculation period affect operating time characteristics. There is also a method of providing a frequency change rate detection function for a high-speed operation. In a load blocking method to which frequency drop detection is applied, there are cases where the blocking target is a load with a long-time limit (=low blocking priority) to avoid overlap with the load blocked during a frequency relay operation. In an emergency, a load with low blocking priority will be blocked first. However, a blocking process is desired to be originally performed from a load with highest blocking priority. In the event of an earthquake, the frequency relay operates a plurality of times and there are cases where an unblocked load is first blocked during second and third frequency relay operations. In the first operation, the load with a short time limit is blocked and the load with a long-time limit remains. Thus, the load blocking times of the second and third operations are later than that of the first operation. Therefore, frequency relays or a system linked thereto are required to suppress a variation in the operating time (fairness) and to perform high-precision frequency calculation in a wide range. Because there is a possibility that the uniformity of equipment finish times cannot be achieved with only a timer, it is possible to collect seismic intensity information, power outage information, load information, and power source information of a wide area from a bird's-eye view via the SNS and it is possible to contribute to minimizing the range of power outages and early resumption of operation of system equipment if a result of big data analysis is used to coordinate and adjust the priority of load blocking.

Examples of adaptive setting changes of various threshold values are as follows.
Because the system flow increases or decreases with a meteorological/weather forecast or real-time information thereof, the improvement of the accuracy of the failure detection more suitable for a real phenomenon and a more exact determination criterion (failure selection performance) of whether or not a blocking instruction should be output with respect to a system event can be obtained by adjusting the blinder arrangement of protective relays or a system linked thereto.
It is possible to contribute to shortening the power outage time and suppressing the expansion of the spread range of a system failure event by changing the short and long time setting of a re-closing timer in accordance with meteorological/weather forecasts or real-time information (snow, rain, and wind).
In so-called muttering, tweeting, following, and the like related to the weather, the meteorological phenomenon, or people's consciousness in a certain specific area on the SNS, the weather/meteorological phenomenon in the time slice can be an electrical characteristic parameter (a line constant or the like) of the power system or a significant parameter for predicting the near future from their correlation based on past performance

According to the fifth embodiment described above, the energy management system 10A can contribute to a process in which the protective relay 200B detects a failure more accurately in accordance with a situation and makes a response of a blocking instruction or the like accurately with respect to a system event.

### Sixth Embodiment

Hereinafter, a sixth embodiment will be described. An energy management system 10A of the sixth embodiment acquires SNS information and performs an information sharing and interlinkage process for a system model and its state simulation result with substation control devices or a substation automation system linked thereto. Interlinkage indicates, for example, that substation control devices or a substation automation system linked thereto perform control on the basis of information obtained from the energy management system 10A. Hereinafter, differences from the first to fifth embodiments will be mainly described.

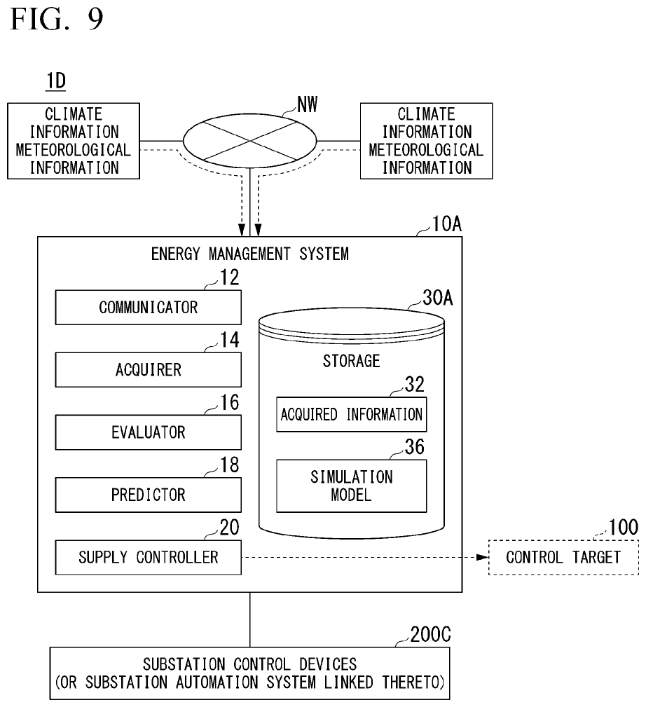

FIG. 9 is a diagram showing an example of a functional configuration of an information processing system 1D of the sixth embodiment. For example, the information processing system 1D includes substation control devices 200C (or a substation automation system linked thereto) in addition to the energy management system 10A.

As in the fifth embodiment described above, a surrounding temperature, seasonal information such as summer and winter, and the like are also important parameters of an algorithm applied to abnormality detection and scheduling. If abnormalities due to actual weather and meteorological factors on system equipment, or power sources such as power generators under management, power sources from renewable energy whose output fluctuates due to weather and a meteorological phenomenon, and load states in which energy usage fluctuates due to weather and a meteorological phenomenon can be predicted in advance, the operation and shutdown of power transmission lines, the tap-switching settings of transformers, and the layout and time-slice optimization of selection of substation bus bars A and B enable stable energy supply, efficient system equipment operation, or planned outage planning of electrical equipment on the system. A planned shutdown plan for electrical equipment on the system can contribute to controlling capital investment by, for example, improving power transmission and distribution efficiency, improving power generation efficiency, optimizing equipment patrol and inspection plans, and optimizing aging equipment renewal plans.

In so-called muttering, tweeting, following, and the like related to the weather, the meteorological phenomenon, or people's consciousness in a certain specific area on the SNS, the weather/meteorological phenomenon in the time slice can be an electrical characteristic parameter (a line constant or the like) of the power system or a significant parameter for predicting the near future from their correlation based on past performance

According to the sixth embodiment described above, the energy management system 10A can contribute to a process in which substation control devices 200C (or a substation automation system linked thereto) perform various types of control according to the situation more accurately.

### Seventh Embodiment

Hereinafter, a seventh embodiment will be described. An energy management system 10A of the seventh embodiment acquires SNS information and performs an information sharing and interlinkage process for a system model and its state simulation result with substation equipment monitoring devices or a substation equipment monitoring system linked thereto. Interlinkage indicates, for example, that the substation equipment monitoring devices or the substation equipment monitoring system linked thereto perform control on the basis of information obtained from the energy management system 10A. Hereinafter, differences from the first to fifth embodiments will be mainly described.

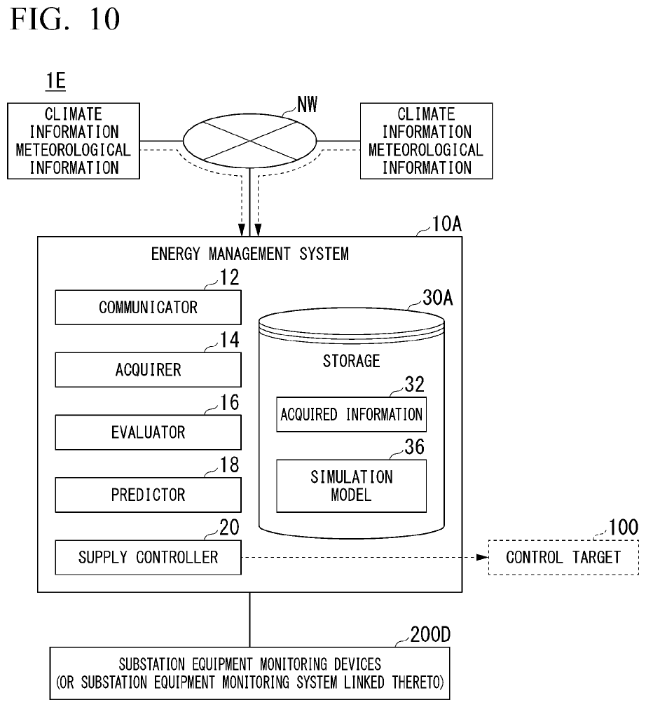

FIG. 10 is a diagram showing an example of a functional configuration of an information processing system 1E of the seventh embodiment. For example, in addition to the energy management system 10A, the information processing system 1E includes substation equipment monitoring devices 200D (or a substation equipment monitoring system linked thereto).

Like the above-described fifth or sixth embodiment, in the energy management system 10A of the seventh embodiment, the surrounding temperature, seasonal information such as summer/winter, and the like are also important parameters for improving the accuracy and performance in a monitoring process to be applied to the substation equipment monitoring devices 200D, or the substation equipment monitoring system linked thereto, a CBM algorithm, deterioration analysis, remaining lifespan analysis, and the like.

In so-called muttering, tweeting, following, and the like related to the weather, the meteorological phenomenon, or people's consciousness in a certain specific area on the SNS, the weather/meteorological phenomenon in the time slice can be an electrical characteristic parameter (a line constant or the like) of the power system or a significant parameter for predicting the near future from their correlation based on past performance In particular, temperature changes and electrical loads due to weather and meteorological phenomena have a significant influence on the deterioration of substation equipment and the remaining lifespan thereof. For example, if keywords related to wind power, a wind direction, and solar radiation are extracted in a specific area, they can alternatively be used for more precise evaluation (dynamic rating) of the deterioration of heating and cooling of substation equipment such as transformers by wind and the remaining lifespan due to the deterioration.

According to the seventh embodiment described above, the energy management system 10A can contribute to a process in which substation equipment monitoring devices 200D (or a substation automation system linked thereto) perform various types of control in accordance with the situation more accurately.

According to the energy management system 10 (10A) of each embodiment described above, a process of increasing an amount of information and improving the accuracy for modeling the power system contributes to improving the accuracy of predictions by simulating the behavior of the power system such as future electrical phenomena and to suppressing errors between future simulation predictions and actual phenomena by reflecting the influence of the ever-changing surrounding environment.

According to the energy management system of the present embodiment, a process of increasing an amount of information and improving the accuracy for modeling the power system contributes to improving the accuracy of predictions by simulating the behavior of the power system such as future electrical phenomena and to suppressing errors between future simulation predictions and actual phenomena by reflecting the influence of the ever-changing surrounding environment.

It is possible to improve functions and performance of a device and a system as well as respective functions by minimizing the number of errors between predictions and actual phenomena according to simulation of phenomena of these current and future power systems and providing related and linked functions and prediction results based on the simulation of the current and future phenomena on the power system with a system stabilization system (a cascading failure prevention relay system), protective relay devices or a system linked thereto, substation control devices or a substation automation system linked thereto, and substation equipment monitoring devices or a substation equipment monitoring system linked thereto as systems.

Also, some or all of the first to seventh embodiments may be arbitrarily combined and implemented.

While several embodiments of the present invention have been described above, these embodiments have been presented by way of example only, and are not intended to limit the scope of the inventions. These embodiments may be embodied in a variety of other forms. Various omissions, substitutions, and combinations may be made without departing from the spirit of the inventions. The inventions described in the accompanying claims and their equivalents are intended to cover such embodiments or modifications as would fall within the scope and spirit of the inventions.

1. An energy management system for managing demand and supply of energy inside of a management area on the basis of results of predicting one or both of the demand and the supply of the energy inside of the management area, the energy management system comprising:
an acquirer configured to acquire information provided by an unspecified user and including at least one of current meteorological situations and predicted future meteorological situations inside of the management area and outside of the management area and social environment situation patterns inside of the management area and outside of the management area acquired via a network;
a predictor configured to predict one or both of an amount of demand for the energy and an amount of power generation in the future inside of the management area by analyzing or evaluating the demand and the supply of the energy on the basis of the information acquired by the acquirer; and
a demand and supply controller configured to control an energy demand and supply balance inside of the management area on the basis of prediction results of the predictor.

2. The energy management system according to claim 1, wherein the information including the at least one of the current meteorological situations and the predicted future meteorological situations inside of the management area and outside of the management area and the social environment situation patterns inside of the management area and outside of the management area is information of a social network service (SNS) on the Internet.

3. The energy management system according to claim 2, wherein the predictor applies the information of the SNS to parameters of a system model with respect to simulations of various electrical phenomena of a system using a preset voltage and a preset current of a power system and the parameters of the system model of system equipment.

4. The energy management system according to claim 3, wherein the information of the SNS is acquired and an information sharing and interlinkage process is performed for the system model and a simulation result based on the system model with a system stabilization system.

5. The energy management system according to claim 3, wherein the information of the SNS is acquired and an information sharing and interlinkage process is performed for the system model and a simulation result based on the system model with a protective relay device or a system linked to the protective relay device.

6. The energy management system according to claim 3, wherein the information of the SNS is acquired and an information sharing and interlinkage process is performed for the system model and a simulation result based on the system model with a substation control device or a substation automation system linked to the substation control device.

7. The energy management system according to claim 3, wherein the information of the SNS is acquired and an information sharing and interlinkage process is performed for the system model and a simulation result based on the system model with a substation equipment monitoring device or a substation equipment monitoring system linked to the substation equipment monitoring device.

8. An energy management method of managing demand and supply of energy inside of a management area on the basis of results of predicting one or both of the demand and the supply of the energy inside of the management area, the energy management method comprising:
acquiring, by a computer, information provided by an unspecified user and including at least one of current meteorological situations and predicted future meteorological situations inside of the management area and outside of the management area and social environment situation patterns inside of the management area and outside of the management area acquired via a network;
predicting, by the computer, one or both of an amount of demand for the energy and an amount of power generation in the future inside of the management area by analyzing or evaluating the demand and the supply of the energy on the basis of the acquired information; and
controlling, by the computer, an energy demand and supply balance inside of the management area on the basis of a prediction result.

9. A non-transitory computer storage medium storing a program for causing a computer to manage demand and supply of energy inside of a management area on the basis of results of predicting one or both of the demand and the supply of the energy inside of the management area, the program causing the computer to:
acquire information provided by an unspecified user and including at least one of current meteorological situations and predicted future meteorological situations inside of the management area and outside of the management area and social environment situation patterns inside of the management area and outside of the management area acquired via a network;
predict one or both of an amount of demand for the energy and an amount of power generation in the future inside of the management area by analyzing or evaluating the demand and the supply of the energy on the basis of the acquired information; and
control an energy demand and supply balance inside of the management area on the basis of a prediction result.
